(19) United States
(12) Patent Application Publication
(10) Pub. No.: US 2022/0019835 A1
(43) Pub. Date: Jan. 20, 2022

(54) IMAGE PROCESSING SYSTEM, APPARATUS, METHOD, AND STORAGE MEDIUM

(71) Applicant: CANON KABUSHIKI KAISHA, Tokyo (JP)

(72) Inventor: Yoshihito Nanaumi, Kanagawa (JP)

(21) Appl. No.: 17/372,277

(22) Filed: Jul. 9, 2021

(30) Foreign Application Priority Data
Jul. 17, 2020 (JP) 2020-123284

(51) Int. Cl. G06K 9/34; G06K 9/46; G06T 7/70; G06T 7/10

(52) U.S. Cl. CPC G06K 9/344; G06K 9/46; G06T 2207/30176; G06T 7/10; G06K 2209/01; G06T 7/70

(57) ABSTRACT

Character recognition processing is executed on a document image, and a candidate segmentation point is specified in a character string of a recognition result of the character recognition processing. In response to a user specifying a desired position on the document image displayed, a character string corresponding to the specified position is set as an output target and the candidate segmentation point is displayed. In a case where the candidate segmentation point is operated by the user, the character string set as the output target is changed to a character string obtained by segmentation based on the operated candidate segmentation point.

### BACKGROUND

### Field

The aspect of the embodiments relates to an image processing system, an apparatus, a method, and a storage medium.

### Description of the Related Art

Management of paper documents includes scanning paper documents and storing them in a digitized form. Conventionally, in digitization of paper documents, some systems perform character recognition and use the recognition result as a file name In an example of such systems, a user selects a character recognition result from a document image, and the selected character recognition result is used as a file name to store the document image in a certain storage. However, since a character recognition result is used, in a case where there is variability in the character recognition result, for example, an excess space is in a character string to be set as a file name, the excess space is consequently included in the file name, which is not desirable. Japanese Patent Application Laid-Open No. 2013-74609 discusses a method for converting a character recognition result into a character string suitable for a file name, such as removing a space at the start of a character string, to use the character recognition result as the file name

However, depending on a user, a range of a character string in a character recognition result selected for a file name may not be desirable. Even in a case where file names are assigned to pieces of similar document image, a range of the character string to be used as a file name may be different for each user, and thus it is difficult to determine a character string to be used in a file name based on one criterion. For example, in a case where a date described in a document image is used in a file name, some users want to also use a character string of an item name (e.g., “a payment date”) associated with the date as the file name, and some users want to use the date as the file name

### SUMMARY

According to an aspect of the embodiments, a system includes a recognition unit configured to execute character recognition processing on a document image, a candidate segmentation unit configured to specify a candidate segmentation point in a character string of a recognition result of the character recognition processing, a display unit configured to display the document image, set a character string corresponding to a position specified by a user on the displayed document image as an output target, and display the candidate segmentation point, and a change unit configured to change, in a case where the displayed candidate segmentation point is operated by the user, the character string set as the output target to a character string based on the candidate segmentation point.

Further features of the present disclosure will become apparent from the following description of exemplary embodiments with reference to the attached drawings.

### BRIEF DESCRIPTION OF THE DRAWINGS

FIG. 1 is a diagram illustrating a system configuration of an image processing system.

FIG. 2 is a diagram illustrating a hardware configuration of an image forming apparatus.

FIGS. 3A and 3B are diagrams illustrating hardware configurations of an image processing server and a user terminal, respectively.

FIGS. 4A and 4B are diagrams each illustrating an example a form image and a character recognition result thereof.

FIG. 5 is a flowchart illustrating a processing procedure according to a first exemplary embodiment.

FIG. 6 is a flowchart illustrating a processing procedure of text segmentation.

FIG. 7 is a flowchart illustrating a processing procedure of candidate segmentation.

FIG. 8 is a flowchart illustrating a processing procedure of text correction.

FIGS. 9A to 9C are diagrams each illustrating a list of regular expression definitions.

FIGS. 10A to 10C are diagrams each illustrating an example of a character recognition result.

FIG. 11 is a diagram illustrating an example indicating positions of a text segmentation result.

FIG. 12 is a diagram illustrating an example indicating positions of a candidate segmentation result.

FIGS. 13A to 13G are diagrams each illustrating an example of a text correction result.

### DESCRIPTION OF THE EMBODIMENTS

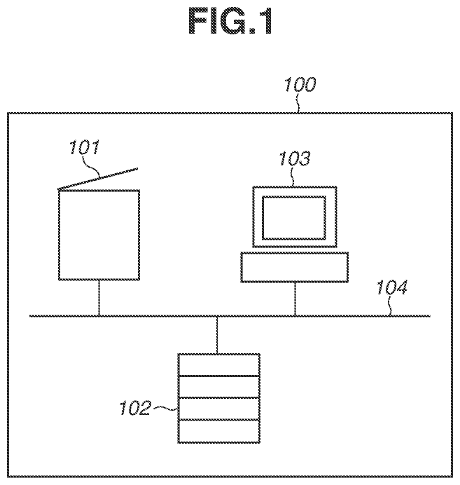

FIG. 1 illustrates a configuration example of an image processing system 100 according to a first exemplary embodiment. The image processing system 100 includes an image forming apparatus 101, an image processing server 102, and a user terminal 103. The image forming apparatus 101, the image processing server 102, and the user terminal 103 are connected to each other via a network 104 and can communicate with each other.

The image forming apparatus 101 is a multifunction peripheral which can receive a print request (print data) of image data from the user terminal 103 and print the received image data, read image data using a scanner provided to the image forming apparatus 101 and print the image data read by the scanner, and the like. The image processing server 102 is an image processing apparatus which can execute image processing described below on image data read by the scanner of the image forming apparatus 101 and transmit the image processing result to the user terminal 103. The image processing server 102 may be a virtual server disposed in the cloud, namely the Internet. The user terminal 103 can perform additional processing on the image processing result received from the image processing server 102 interactively with a user via an application having a user interface. According to the present exemplary embodiment, the user terminal 103 is a general personal computer (PC) provided with a display, a keyboard, and a mouse, but may be, for example, a mobile terminal having a touch panel.

According to the present exemplary embodiment, a description will be given of a series of data input support processing in which the image forming apparatus 101 scans a paper form, such as an invoice, the image processing server 102 extracts information to be used from the scanned image and electronically stores the extracted result, and the user terminal 103 provides a user interface on which a user can check and correct the extracted result.

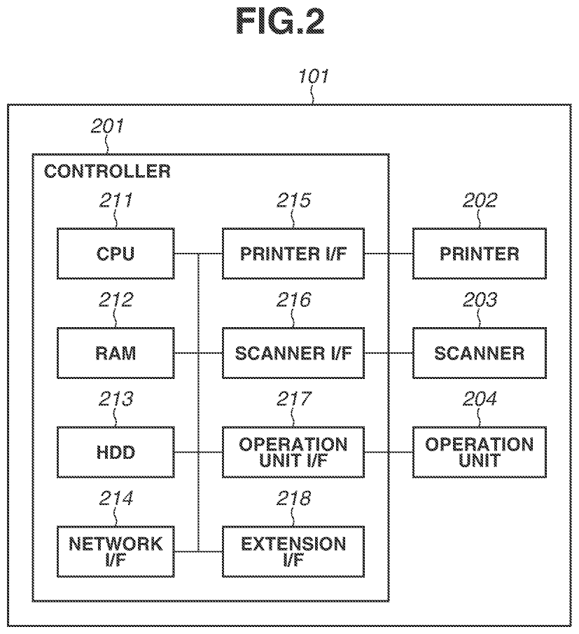

FIG. 2 illustrates an example of a configuration of the image forming apparatus 101. The image forming apparatus 101 includes a controller 201, a printer 202, a scanner 203, and an operation unit 204. The controller 201 includes a central processing unit (CPU) 211, a random access memory (RAM) 212, a hard disk drive (HDD) 213, a network interface (I/F) 214, a printer I/F 215, a scanner I/F 216, an operation unit I/F 217, and an extension I/F 218.

The CPU 211 controls the entire image forming apparatus 101. The CPU 211 can control an exchange of data with the RAM 212, the HDD 213, the network I/F 214, the printer I/F 215, the scanner I/F 216, the operation unit I/F 217, and the extension I/F 218. The CPU 211 develops a control program (a command) read from the HDD 213 in the RAM 212 and executes the command developed in the RAM 212. The HDD 213 stores a control program that can be executed by the CPU 211, a setting value that is used in the image forming apparatus 101, data related to processing requested by a user, and the like. The RAM 212 has an area for temporarily storing a command read by the CPU 211 from the HDD 213. The RAM 212 can also store various types of data for executing a command For example, in image processing, the CPU 211 can perform processing by developing input data in the RAM 212.

The network I/F 214 is an interface for performing network communication with an apparatus in the image processing system 100. The network I/F 214 can notify the CPU 211 of data reception and transmit data held on the RAM 212 to the network 104. The printer I/F 215 can transmit print data transmitted from the CPU 211 to the printer 202 and a printer status received from the printer 202 to the CPU 211. The scanner I/F 216 can transmit an image reading instruction transmitted from the CPU 211 to the scanner 203 and transmit image data and a status received from the scanner 203 to the CPU 211. The operation unit I/F 217 can transmit a user's instruction input via the operation unit 204 to the CPU 211 and screen information for an operation to be performed by the user to the operation unit 204. The extension I/F 218 is an interface for connecting an external device to the image forming apparatus 101. The extension I/F 218 includes, for example, a Universal Serial Bus (USB) type interface. In a case where an external storage device, such as a USB memory, is connected to the extension I/F 218, the image forming apparatus 101 can read data stored in the external storage device and write data to the external storage device.

The printer 202 can print image data received from the printer I/F 215 on a sheet and transmit the state of the printer 202 to the printer I/F 215.

The scanner 203 can read information on a sheet placed on a reading unit and digitize the read information according to the image reading instruction received from the scanner I/F 216 and transmit the digitized information to the scanner I/F 216. The scanner 203 can transmit its status to the scanner I/F 216.

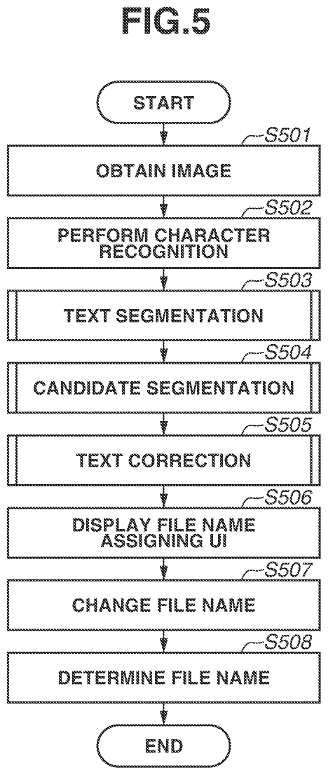

The operation unit 204 is an interface on which a user performs an operation for issuing various instructions to the image forming apparatus 101. For example, the operation unit 204 is provided with a liquid crystal screen including a touch panel to provide an operation screen to a user of the image forming apparatus 101 and receive an operation from the user. The operation unit 204 will be described in detail below with reference to FIG. 5.

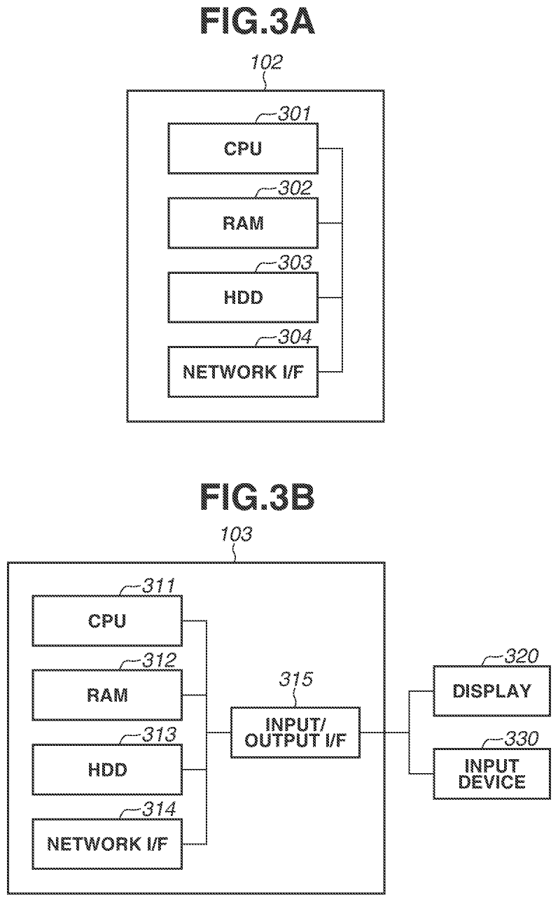

FIG. 3A illustrates an example of a configuration of the image processing server 102. The image processing server 102 includes a CPU 301, a RAM 302, an HDD 303, and a network I/F 304. The CPU 301 controls the entire image processing server 102. The CPU 301 can control an exchange of data with the RAM 302, the HDD 303, and the network I/F 304. The CPU 301 develops a control program (a command) read from the HDD 303 in the RAM 302 and executes the command developed in the RAM 302.

FIG. 3B illustrates an example of a configuration of the user terminal 103. The user terminal 103 includes a CPU 311, a RAM 312, an HDD 313, a network I/F 314, and an input/output I/F 315. The CPU 311 controls the entire user terminal 103. The CPU 311 can control an exchange of data with the RAM 312, the HDD 313, the network I/F 314, and the input/output I/F 315. A display 320 includes a display device, such as a liquid crystal display, and displays display information received from the input/output I/F 315. An input device 330 includes a pointing device, such as a mouse and a touch panel and a keyboard, receives an operation from a user, and transmits operation information to the input/output I/F 315. The HDD 313 can store an image processing result received from the image processing server 102 via the network I/F 314. According to the present exemplary embodiment, the CPU 311 develops an application program read from the HDD 313 in the RAM 312 and performs display of the display information and reception of a user operation via the input/output I/F 315.

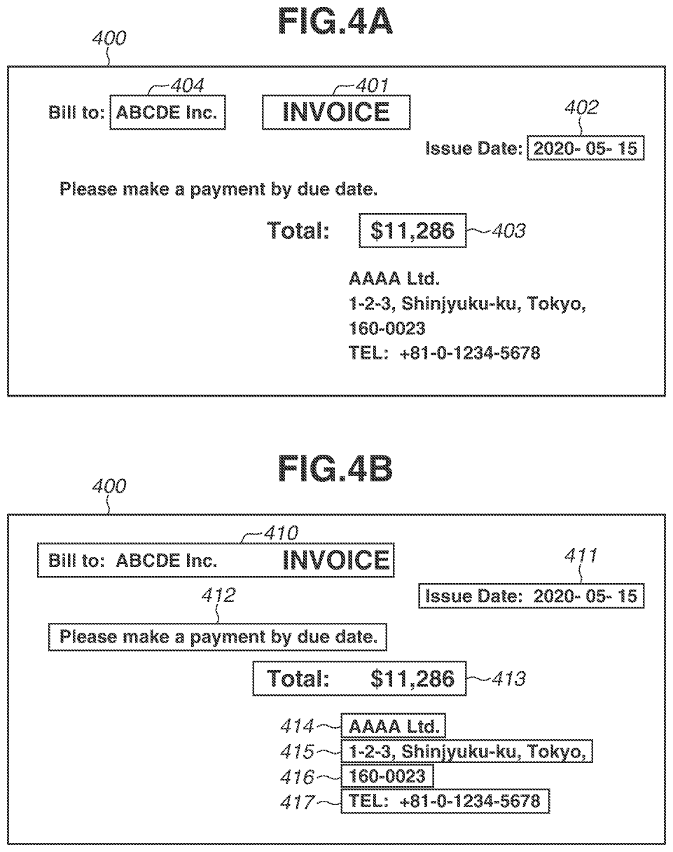

FIG. 4A illustrates a form image 400 which is an example case according to the present exemplary embodiment. The form image 400 is an image obtained by reading a paper document (e.g., an invoice) with the scanner 203 of the image forming apparatus 101. Item values 401 to 404 are examples of character strings to be extraction targets in the image processing system 100. In FIG. 4A, the item value 401 is a character string of a title indicating a content of the document, the item value 402 is a character string of a date indicating an issue date, the item value 403 is a character string of a billing amount, and the item value 404 is a character string of a name of a billing destination. In the example in FIG. 4A, each of the item values 401 to 404 is surrounded by a rectangular frame for indicating its position, but the rectangular frame is not included in the form image obtained by scanning

FIG. 4B illustrates an example of character strings (optical character recognition (OCR) character strings) in a character recognition result obtained in a case where area analysis processing and OCR processing are executed on the form image 400. Eight character areas of character strings 410 to 417 are identified, and an OCR character string is extracted from each character area. In FIG. 4B, a position corresponding to each character area extracted based on results of the area analysis processing and the OCR processing is indicated by a rectangular frame. The character string 410 is obtained as a character string corresponding to one character area including the character string of the item value 401 and a character string on a left side of the item value 401. The character string 411 is extracted as a character string corresponding to one character area including the character string of the item value 402 and a character string on a left side of the item value 402. The character string 413 is also extracted as a character string corresponding to an area including the character string of the item value 403 and a character string on a left side of the item value 403.

A case in which the above-described character strings are used to generate a file name of the form image according to a user's instruction is taken as an example case. A description will be given of, for example, a user interface (UI) in which in a case where a user clicks a desired position on the form image, a character area corresponding to the clicked position and based on the area analysis result in FIG. 4B is selected.

In such a UI, in a case where a user performs a click on a character string “ABCDE” to specify the character string “ABCDE”, a character string in a character area based on the area analysis result (namely, a character string “Bill to: ABCDE Inc. INVOICE” in the character string 410) is selected. In a case where the user wants to select a part of “ABCDE Inc.” as a file name, the user is to perform an operation to delete excess character strings “Bill to:” and “INVOICE” from the selected character string. On the other hand, in a case where a different user who wants to assign “Bill to ABCDE Inc.” to the file name performs the operation, the different user is to perform an operation to delete the excess character string “INVOICE” from the character string “Bill to: ABCDE Inc. INVOICE” specified by the click.

A description will be given of a correction operation UI on which the user can easily perform correction in a case where a character string of a character recognition result is not a character string desired by the user using the system which assigns a file name based on a character string of a character recognition result of a character area corresponding to a position specified by the user.

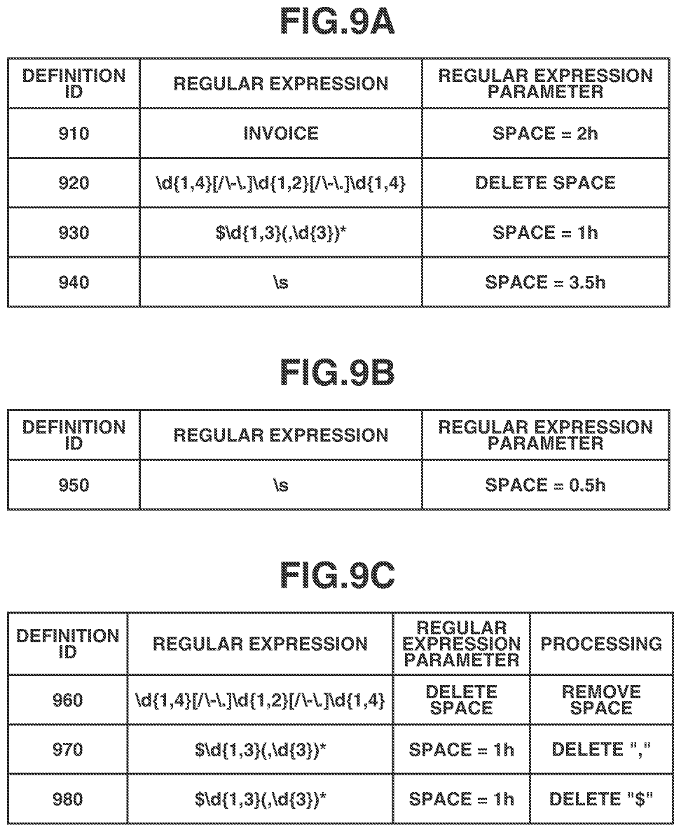

Regular expression definition lists in FIGS. 9A to 9C are described before describing processing procedures according to the present exemplary embodiment.

The list in FIG. 9A is an example indicating a plurality of regular expression definitions in a table format that is used in text segmentation processing in step S503 described below. In the list in FIG. 9A, a definition is set by associating each definition identification (ID) with a combination of a regular expression and a regular expression parameter. The plurality of regular expression definitions defined in advance in the list is stored in the HDD 303 of the image processing server 102. The regular expression describes an item to be extracted, for example, a date, a telephone number, an amount of money, and a character included in a document title, namely a character string to be an extraction target in one regular expression. The regular expression parameter is defined for each regular expression and is a parameter for how to interpret an OCR character string to be a target of a regular expression search. For example, the parameter describes to which extent of a distance between adjacent characters is processed as a whitespace character (a space).

In the list in FIG. 9A, four regular expression definition IDs 910 to 940 are defined.

The regular expression definition ID 910 includes the regular expression of “INVOICE” and the regular expression parameter of “space=2h”. With the regular expression, the character string of “INVOICE” can be searched as a matching pattern. The regular expression parameter of “space=2h” indicates that in a case where a distance between adjacent characters is two times or more of a character height (h), a whitespace character is inserted and processed when an OCR character string is converted into a search target character string. According to the present exemplary embodiment, the regular expression parameter is specified using a character height as a threshold value for processing as a whitespace character. However, for example, a pixel size of an image, a physical distance on a paper surface, and an average character width may be used as a criterion.

The regular expression definition ID 920 is a regular expression definition relating a date and includes the regular expression of “\d{1,4}[Λ\.]\d{1,2}[Λ-\.]\d{1,4}” and the regular expression parameter of “delete space”. The regular expression of “\d{1,4}[Λ-\.]\d{1,2}[Λ-\.]\d{1,4}” represents a pattern which is a combination of a one to four digit number, a predetermined delimiter (any of “/ (slash)”, “- (hyphen)”, and “. (comma)”), a one to two digit number, the predetermined delimiter (any of “/”, “-”, and “.”), and a one to four digit number, and with which a character string of a date matching this pattern can be searched. The regular expression parameter of “delete space” indicates that a whitespace character is not inserted regardless of the distance between the adjacent characters in a case where the OCR character string is converted into the search target character string.

The regular expression definition ID 930 includes the regular expression of “$\d{1,3}(,\d{3})*” and the regular expression parameter of “space=1h”. The regular expression of “$\d{1,3}(\d{3})*” represents a pattern which is a combination of a “$” sign, a one to three digit number, and “repeat of a comma or a one to three digit number”, and with which a character string indicating an amount of money matching this pattern can be searched. The regular expression parameter of “space=1 h” indicates that if the distance between the adjacent characters is one or more character heights based on the character height (h), a whitespace character is inserted and processed in a case where the OCR character string is converted into the search target character string.

The regular expression definition ID 940 includes the regular expression of “ \s” and the regular expression parameter of “space=3.5h”. The regular expression definition ID 940 represents a pattern of a whitespace character (\s), and with which the character string of the whitespace character can be searched. The regular expression parameter of “space=3.5h” indicates that if the distance between the adjacent characters is 3.5 times or more of the character height based on the character height, the whitespace character is inserted and processed in a case where text information is converted into the search target character string. In other words, the regular expression definition ID 940 is a pattern description with which the whitespace character is inserted between characters, if a distance between the characters is 3.5 times or more of the character height, while the whitespace character matches the regular expression.

The list in FIG. 9B is an example indicating one or a plurality of regular expression definitions in a table format that is used in candidate segmentation processing in step S504 described below. The list in FIG. 9B has a format, similar to the list in FIG. 9A, in which a definition is set by associating each definition ID with a combination of the regular expression and the regular expression parameter. In the example of the regular expression definition list in FIG. 9B, a regular expression definition ID 950 is defined.

The regular expression definition ID 950 includes the regular expression of “\s” and the regular expression parameter of “space=0.5 h”. The regular expression definition ID 950 represents the pattern of the whitespace character (\s), and with which the character string of the whitespace character can be searched. The regular expression parameter of “space=0.5h” indicates that if the distance between the adjacent characters is 0.5 times or more of the character height (h), the whitespace character is inserted and processed in a case where character string information as a text segmentation result is converted into the search target character string. In other words, the regular expression definition ID 950 is a pattern description with which the whitespace character is inserted between characters, if a distance therebetween is 0.5 times or more of the character height, while the whitespace character matches the regular expression.

The list in FIG. 9C is an example indicating a plurality of regular expression definitions in table format that is used in text correction processing in step S505 described below. In the list in FIG. 9C, a definition is set by associating each definition ID with the regular expression, the regular expression parameter, and processing to be executed on the text information matching the regular expression. The definition list is stored in the HDD 303 of the image processing server 102.

A regular expression definition ID 960 is associated with a regular expression and a regular expression parameter similar to those of the regular expression definition ID 920, and processing to be executed in a case of matching the regular expression is for removing the whitespace character from the matched text information.

A regular expression definition ID 970 is associated with a regular expression and a regular expression parameter similar to those of the regular expression definition ID 930, and processing to be executed in a case of matching the regular expression is for removing “,” from the matched text information.

A regular expression definition ID 980 is associated with a regular expression and a regular expression parameter similar to those of the regular expression definition ID 930, and processing to be executed in a case of matching the regular expression is for removing “$” from the matched text information.

A description will be given of image processing according to the present exemplary embodiment with reference to flowcharts in FIGS. 5 to 8 using the form image 400 in FIGS. 4A and 4B and the lists in FIGS. 9A to 9C.

In step S501 in FIG. 5, the CPU 211 of the image forming apparatus 101 transmits the form image 400 read by the scanner 203 to the image processing server 102. The image processing server 102 obtains the form image 400 transmitted from the image forming apparatus 101.

In step S502, the CPU 301 of the image processing server 102 performs the area analysis processing on the form image 400 to identify a character area and performs character recognition processing on the character area. As a result of the character recognition processing, the CPU 301 obtains coordinates of a character area (a character block), coordinates of each character in the character area, and a character code of the character recognition result. An array of the character code in the character area unit obtained in step S502 is referred to as an OCR character string (a character string of a character recognition result). As a result of the character recognition processing performed on the form image 400, the character strings 410 to 417 are obtained as the OCR character strings as illustrated in FIG. 4B.

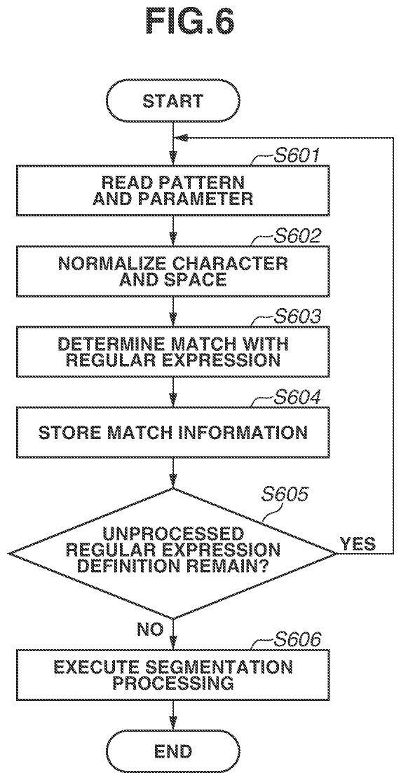

In step S503, the CPU 301 of the image processing server 102 performs the text segmentation processing. The text segmentation processing is described in detail with reference to the flowchart in FIG. 6.

In step S601 in FIG. 6, the CPU 301 of the image processing server 102 sets one of the regular expression definitions (e.g., the regular expression definition ID 910) in the list in FIG. 9A stored in the HDD 303 as a processing target.

In step S602, the CPU 301 of the image processing server 102 interprets the character string of the character recognition result obtained in step S502, based on the regular expression parameter of the regular expression definition set as the processing target in step S601, and normalizes the character string as a search target character string.

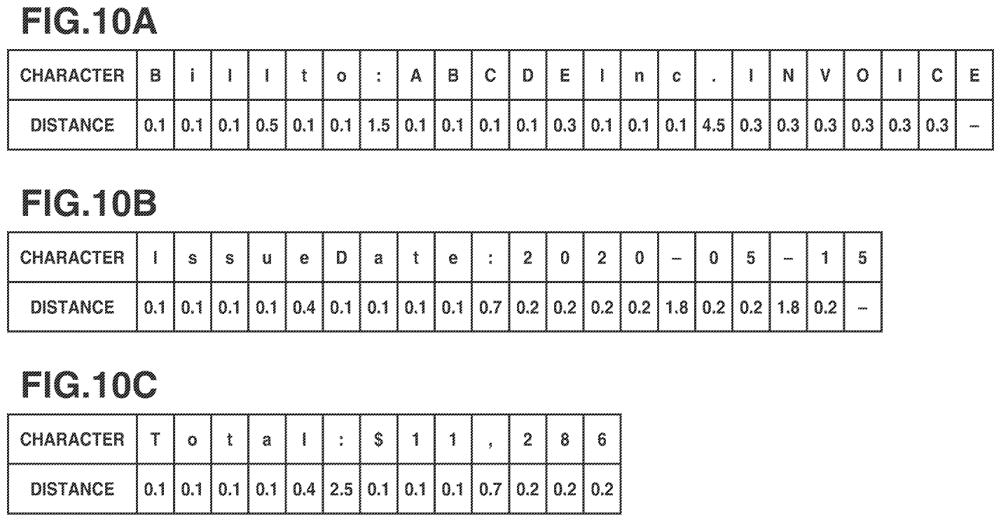

FIGS. 10A to 10C illustrate examples of the character recognition results. The character recognition result in FIG. 10A is the character recognition result of the character string 410. The character recognition result in FIG. 10B is the character recognition result of the character string 411. The character recognition result in FIG. 10C is the character recognition result of the character string 413. A character row in each table of the character recognition results in FIGS. 10A to 10C indicates characters in each recognition result, and a distance row indicates a distance to a next character based on the character height as a relative reference. The regular expression parameter of the regular expression definition ID 910 is “space=2h”, which indicates that if the distance between characters is two or more character heights based on the character height as the relative reference, the distance is determined as the whitespace character. In the character recognition result in FIG. 10A, since a character “.” is separated from the adjacent character “I” by a distance corresponding to 4.5 times of the character height, a whitespace character is inserted between the character “.” and the adjacent character “I”, and a search target character string “Billto:ABCDEInc.□INVOICE” is generated (Here, □ indicates a whitespace character for convenience in writing).

Since the search target character string changes for each regular expression parameter, in a case where the regular expression parameter is defined as “space=1 h”, a whitespace character is further inserted between “:” and “A”, and the search target character string will be “Billto:□ABCDEInc□INVOICE”. In a case where the regular expression parameter is defined as “delete space”, the search target character string will be “Billto:ABCDEInc.INVOICE”.

The processing in step S602 is similarly executed on the remaining character recognition results (character strings) 411 to 417 to generate the search target character strings for all the character strings.

In step S603, the CPU 301 of the image processing server 102 performs regular expression search for determining whether the search target character string obtained in step S602 matches the regular expression of the regular expression definition set as the processing target in step S601.

In a case where the regular expression in FIG. 9A is searched for in the search target character string “BilltO:ABCDEInc.□INVOICE” of the character string 410, the part “INVOICE” matches the regular expression. Subsequently, as a result of searching for the regular expression in FIG. 9A in the search target character string “IssueDate:2020-□05□15” of the character string 411, a matching part is not obtained. The processing is similarly executed on the remaining character strings 412 to 417 using the regular expression in FIG. 9A, and as a result, the regular expression does not match the other search target character strings.

In step S604, the CPU 301 of the image processing server 102 stores match information about “INVOICE” obtained as the search result in step S603 in the RAM 302.

In step S605, the CPU 301 of the image processing server 102 determines whether an unprocessed regular expression definition remains. In a case where the unprocessed regular expression definition remains (YES in step S605), the processing returns to step S601 and repeats similar processing by setting one of the unprocessed regular expression definitions as a next processing target.

For example, in a case where the regular expression definition ID 910 is set as the first processing target, the regular expression definition ID 920 is the next processing target. In this case, in step S601, the search target character string is generated with respect to the character recognition result in FIG. 10B, based on the parameter of the regular expression definition ID 920. Since the parameter of the regular expression definition ID 920 is “delete space”, and a whitespace character is not inserted regardless of the distance between characters, “IssueDate:May 15, 2020” is obtained as the search target character string from the character recognition result in FIG. 10B. The search result of “May 15, 2020” is obtained as a part matching the regular expression of the regular expression definition ID 920.

Similarly, in a case where the regular expression definition ID 930 is set as the processing target, in step S602, search target character string“Total:□11,286” as the search target character string is generated with respect to the character recognition result in FIG. 10C, based on the parameter “space=1 h” of the regular expression definition ID 930. In step S603, “$11,286” is searched as a part matching the regular expression of the regular expression definition ID 930.

In step S606, the CPU 301 of the image processing server 102 executes the text segmentation processing on the character string, based on the search result stored in the RAM 302 by the processing in step S604. The text segmentation processing is to segment the OCR character string at both ends of the part matching with the regular expression in the character string of the OCR result. For example, “BilltO:ABCDEInc.□INVOICE” in the character string 410 is segmented at right and left sides of “INVOICE” as delimiters of the character string. However, the right side of “INVOICE” is a right end of the OCR character string, so that the character string is not segmented, and the character string 410 is segmented into two character strings at a position on the left side of “INVOICE” (namely, between “.” and “I”). The text segmentation processing is similarly performed on “May 15, 2020” and “11,286”, and the processing in the flowchart in FIG. 6 is terminated. The character string after segmented by the text segmentation processing is referred to as a text segmentation result. The text segmentation result includes text information indicating the segmented character string and character position information about a circumscribed rectangle of each character.

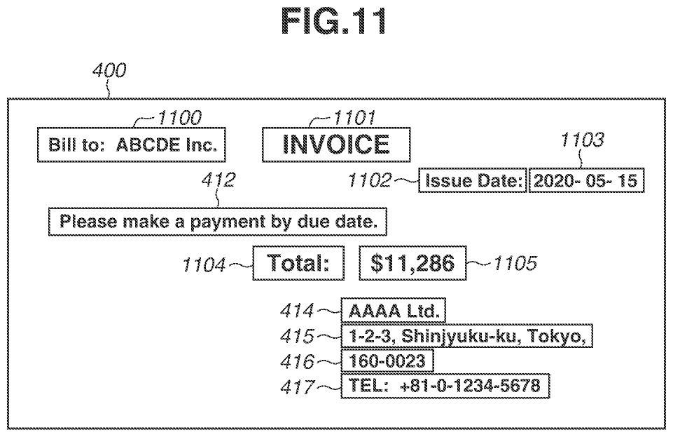

FIG. 11 illustrates the text segmentation result after the text segmentation processing described in detail in FIG. 6 to the form image 400. The character string 410 of the character recognition result is segmented into text segmentation results 1100 and 1101, the character string 411 of the character recognition result is segmented into text segmentation results 1102 and 1103, and the character string 413 of the character recognition result is segmented into text segmentation results 1104 and 1105. The character recognition results (character strings) 412, 414 to 417 remain unchanged.

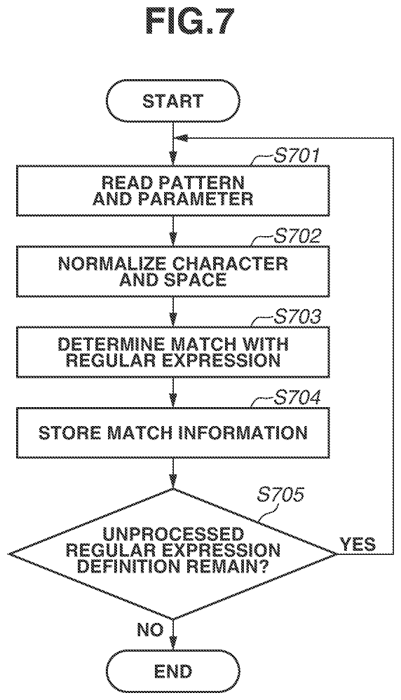

In step S504, the CPU 301 of the image processing server 102 performs the candidate segmentation processing. The candidate segmentation processing is described in detail with reference to the flowchart in FIG. 7.

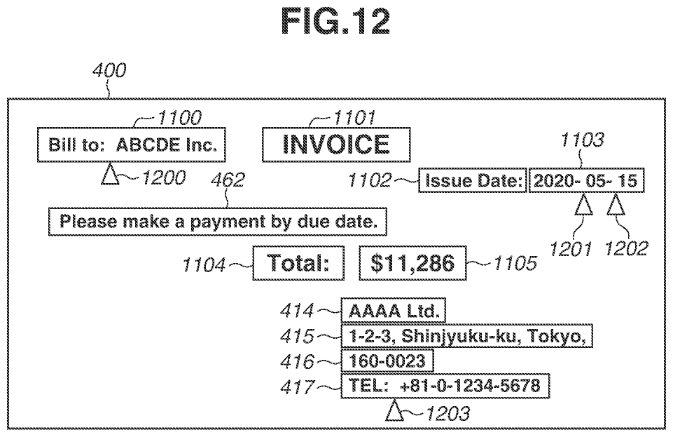

In step S701 in FIG. 7, the CPU 301 of the image processing server 102 selects one of the regular expression definitions (the regular expression definition ID 950) from the list in FIG. 9B stored in the HDD 303 as the processing target. The CPU 301 executes processing in steps S702 to S705 to determine whether a pattern which matches the regular expression definition selected as the processing target exists in the text segmentation results obtained by the text segmentation processing in step S503. Since processing in steps S702 to S705 is similar to that in steps S602 to S605, a detailed redundant description thereof is omitted. In the example of the list in FIG. 9B, since only one regular expression definition ID 950 is defined, the whitespace character position inserted in step S702 is searched in step S703, and the searched whitespace character position is stored as a position matching the regular expression in step S704. Information about the stored whitespace character position is used as a position of a candidate segmentation point in a UI in FIG. 12 which is displayed in step S506 which is described below.

In the regular expression definition list in FIG. 9B, only the regular expression definition ID 950 for specifying the position of a whitespace character is defined, but the regular expression definition is not limited to this one. The regular expression may be defined to be able to search for, for example, a position of “:” (colon) or “;” (semicolon). In a case where the position of “:” (colon) or “;” (semicolon) is searched for, there is no need to insert a whitespace character, and thus the regular expression parameter may be “delete space”.

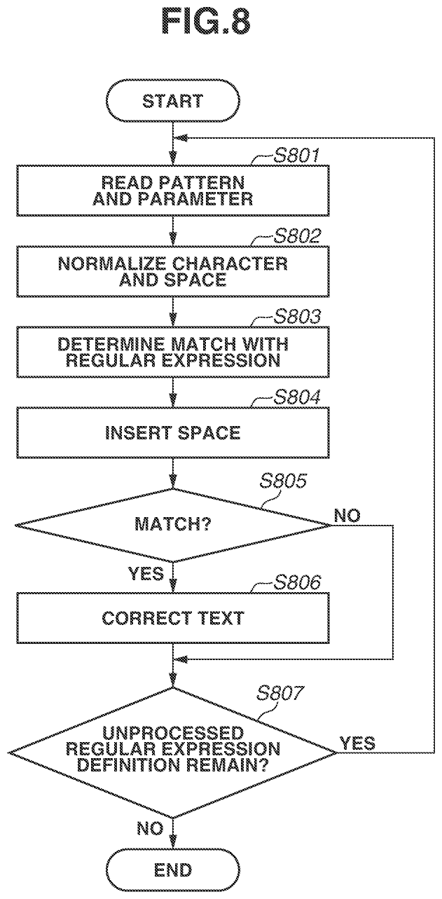

In step S505, the CPU 301 of the image processing server 102 performs the text correction processing. A description will be given of the text correction processing in detail with reference to the flowchart in FIG. 8.

In step S801 in FIG. 8, the CPU 301 of the image processing server 102 sets one of the regular expression definitions in the list in FIG. 9C stored in the HDD 303 as the processing target. For example, the CPU 301 sets the regular expression definition ID 960, the regular expression definition ID 970, and the regular expression definition ID 980 as the processing target one by one in this order and repeatedly performs processing in steps S802 to S807. Processing in steps S802 and S803 is to determine whether the text segmentation results obtained by the text segmentation processing in step S503 include a pattern which matches the regular expression definition set as the processing target, which is similar to that in steps S602 and S603. Thus, a detailed redundant description thereof is omitted.

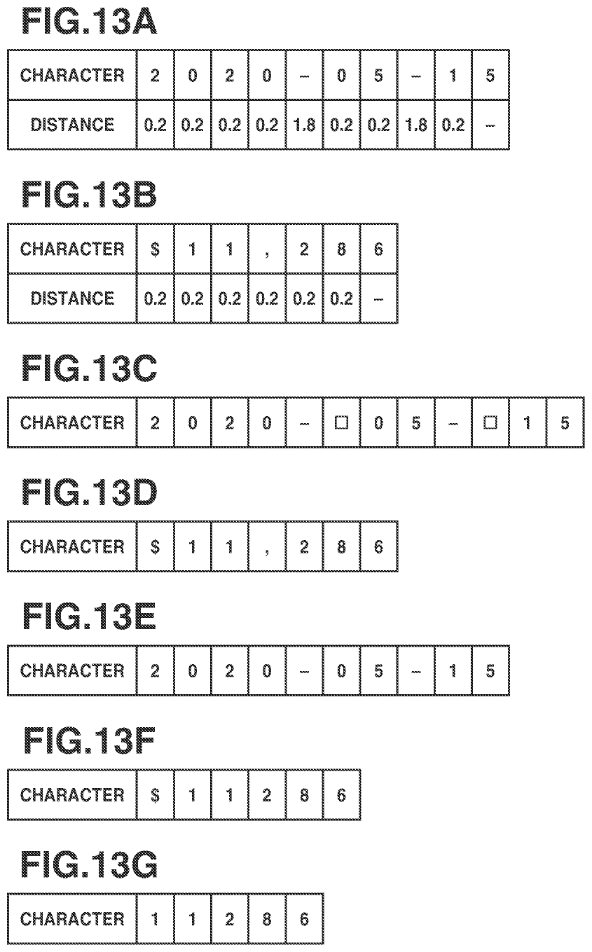

FIG. 13A illustrates a character string which is determined that the character string matches with the regular expression definition ID 960 in the character strings of the text segmentation results. A character row and a distance row in a table in FIG. 13A respectively indicate recognized characters and character heights relative distance to the next character. FIG. 13B illustrates a character string which is determined that the character string matches with the regular expression definition ID 970 and the regular expression definition ID 980 in the character strings in the text segmentation results.

In step S804, the CPU 301 of the image processing server 102 inserts a whitespace character into the text information about the character recognition result and the text information about the text segmentation result, based on the distance between characters defined in advance. According to the present exemplary embodiment, a whitespace character is inserted based on “space=0.5h”. For example, in a case where the space insertion processing in step S804 is performed on the text segmentation result in FIG. 13A, a space insertion result in FIG. 13C is obtained. In a case where the space insertion processing in step S804 is performed on the text segmentation result in FIG. 13B, a whitespace character is not inserted as a result, and a space insertion result in FIG. 13D is obtained.

In step S805, the CPU 301 of the image processing server 102 sets the character string determined to match the regular expression definition in step S803 as a target (YES in step S805), and advances the processing to step S806. Text segmentation results 1103 and 1105 are the matched character strings and thus will be the processing target in step S806. The character string which is not determined to match the regular expression definition in step S803 (NO in step S805) will not be the processing target in step S806, and the processing proceeds to step S807.

In step S806, the CPU 301 of the image processing server 102 executes processing associated with the regular expression definition on the processing target. To the text segmentation result 1103 which matches the regular expression definition ID 960, a whitespace character is inserted in step S804 and becomes the character string in FIG. 13C. However, the processing associated with the regular expression definition ID 960 in step S806 is to delete a whitespace character, and as a result, a text correction result in FIG. 13E is obtained. Regarding the text segmentation result in FIG. 13B which matches the regular expression definition ID 970, the processing associated with the regular expression definition ID 970 (the processing to remove “,”) is executed on the character string in FIG. 13D after subjected to the processing in step S804, and a text correction result in FIG. 13F is obtained. Since the text segmentation result in FIG. 13B also matches the regular expression definition ID 980, the processing associated with the regular expression definition ID 980 (the processing to remove “$”) is further executed on the text correction result in FIG. 13F, and a text correction result in FIG. 13G is obtained.

In step S506, the CPU 301 of the image processing server 102 transmits information for causing the user terminal 103 to display a UI screen for assigning a file name The information to be transmitted includes a document image for display, the character string of the character recognition result in each character area, each character area position information, and position information about the candidate segmentation point. The CPU 311 of the user terminal 103 displays the document image on the display 320, based on the received information. In a case where the user specifies a desired position on the document image, the CPU 311 displays a UI for assigning a file name based on a character string corresponding to the specified position. The UI screen may be displayed by a web application that is displayed via a web browser included in the user terminal 103 or by a dedicated application.

FIG. 12 schematically illustrates which positions on the document image correspond to the positions of the character string of the text segmentation processing result in step S503 and the position of the candidate segmentation point of the candidate segmentation processing result in step S504. The positions of the character strings of the text segmentation processing results in step S503 are indicated by the text segmentation results 1100 to 1105, like in FIG. 11. The positions of the candidate segmentation processing results in step S504 are indicated by candidate segmentation points 1200 to 1203. The candidate segmentation point 1200 indicates the position of the whitespace character matched in the processing in step S703 as the candidate segmentation point in the text segmentation result 1100. The candidate segmentation points 1201 and 1202 indicate the positions matched in the processing in step S703 in the text segmentation result 1103. The candidate segmentation point 1203 indicates the position of the whitespace character matched in the processing in step S703 as the candidate segmentation point in the character string 417 of the character recognition result.

In a case where a user specifies a desired position on the document image on the UI screen for assigning a file name displayed in step S506, an area of the character string (any of areas of the character strings 412 to 417, and the text segmentation results 1100 to 1105 in FIG. 12) corresponding to the specified position is focused, and a recognition result of the character string is input to a file name input field. The candidate segmentation points 1200 to 1203 are normally hidden, but in a case where the candidate segmentation points are set with respect to the focused area, the positions of the candidate segmentation points are displayed at the time of the focus to allow a user to select the candidate segmentation point. For example, in a case where a position specified by a user is a position corresponding to the text segmentation result 1100, an area of the text segmentation result 1100 is focused and displayed, and the candidate segmentation point 1200 is displayed to be able to be specified. The position of the candidate segmentation point may be displayed with a triangular mark as illustrated in FIG. 12 or another mark, such as a vertical bar.

In step S507, the CPU 311 of the user terminal 103 changes the character string as the file name by correcting a character string already input in the file name input field, by using an operation by the user to the candidate segmentation point as a trigger. For example, in a case where the character string “Bill to: ABCDE Inc.” in the area which is focused and displayed by a click operation on the document image by the user is not the character string desired by the user, the user further performs an operation to press the candidate segmentation point 1200 and thus can correct the text segmentation result and obtain “ABCDE Inc.” as an output result. In a case where “May 15, 2020” in the text segmentation result 1103 is not the output result desired by the user, the user can correct the text segmentation result and obtain “May 2020” as an output text by pressing the candidate segmentation point 1202.

According to the present exemplary embodiment, in a case where a user performs a click operation (or a touch operation) at the candidate segmentation point, the character string on the left side of the candidate segmentation point is output, but the disclosure is not limited to this configuration.

For example, in a case where a user performs an operation to press the candidate segmentation point and drag toward the right side, the character string on the right side of the candidate segmentation point may become an output target, whereas in a case where the user performs an operation to press the candidate segmentation point and drag toward the left side, the character string on the left side of the candidate segmentation point may become the output target. As described above, in a case where a predetermined operation is performed on the candidate segmentation point, any character string segmented at the candidate segmentation point may become the output target.

In step S508, in a case where the user performs a file name determination operation, the CPU 311 of the user terminal 103 determines the file name to be assigned to the document image based on the character string input in the file name input field in the processing in steps S506 and S507. The CPU 311 of the user terminal 103 transmits information about the determined file name to the image processing server 102 to associate the information about the determined file name with the document image.

According to the present exemplary embodiment, the file name is determined on the UI screen displayed on the user terminal 103, and then the information about the determined file name is displayed on the image processing server 102 in the processing in steps S506 to S508, but the disclosure is not limited to this configuration. For example, the user terminal 103 may be configured to notify the image processing server 102 of information about the input or changed character string each time a user specifies the character string or operates the candidate segmentation point.

The image processing according to the present exemplary embodiment is applied as described above, and thus a user can select and assign the character recognition result and the text segmentation result to the file name Further, in a case where the selected area is not a desired result of the user, the user can correct the character recognition result and the text segmentation result by performing a predetermined operation on the candidate segmentation point and correct an output text accordingly.

According to the present exemplary embodiment, a language setting of the character recognition processing is described in English. However, the disclosure is not limited to English, and in a case where a character recognition language is Japanese, the regular expression definition corresponding to Japanese may be read and executed. Further, the language may be estimated for each line at the time of character recognition without specification of the language by the user, and the regular expression definition to be read at the time of text segmentation may be changed and executed for each language estimation result. Furthermore, a form may be classified before character recognition, and the regular expression definition to be read at the time of text segmentation may be changed and executed for each classification result.

### Other Embodiments

Embodiments of the present disclosure can also be realized by a computer of a system or apparatus that reads out and executes computer executable instructions recorded on a storage medium (e.g., non-transitory computer-readable storage medium) to perform the functions of one or more of the above-described embodiment(s) of the present disclosure, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-123284, filed Jul. 17, 2020, which is hereby incorporated by reference herein in its entirety.

What is claimed is:

1. A system comprising:
a recognition unit configured to execute character recognition processing on a document image;
a candidate segmentation unit configured to specify a candidate segmentation point in a character string of a recognition result of the character recognition processing;
a display unit configured to display the document image, set a character string corresponding to a position specified by a user on the displayed document image as an output target, and display the candidate segmentation point; and
a change unit configured to change, in a case where the displayed candidate segmentation point is operated by the user, the character string set as the output target to a character string based on the candidate segmentation point.

2. The system according to claim 1, further comprising:
a text segmentation unit configured to segment the character string of the recognition result, using a regular expression definition which associates a regular expression with a parameter relating to a whitespace character,
wherein the candidate segmentation unit specifies the candidate segmentation point in the character string of the recognition result and in a character string obtained by segmentation performed by the text segmentation unit.

3. The system according to claim 1, wherein the display unit sets the character string corresponding to the specified position, identifiably displays an area corresponding to the character string on the document image, and displays the candidate segmentation point.

4. The system according to claim 1, wherein the candidate segmentation unit specifies the candidate segmentation point, based on a position of a predetermined character in a character string.

5. The system according to claim 4, wherein the candidate segmentation unit searches for the position of the predetermined character in the character string, using a regular expression definition which associates a regular expression for searching for the predetermined character with a parameter relating to a whitespace character, and specifies the candidate segmentation point, based on the searched position.

6. The system according to claim 4, wherein the predetermined character is a whitespace character, and the candidate segmentation unit specifies the candidate segmentation point, based on a position of the whitespace character in a character string.

7. The system according to claim 4, wherein the candidate segmentation unit specifies the candidate segmentation point, based on a position of a colon in a character string.

8. The system according to claim 4, wherein the predetermined character is a semicolon, and the candidate segmentation unit specifies the candidate segmentation point, based on a position of the semicolon in a character string.

9. The system according to claim 1, wherein the change unit changes the character string set as the output target to a character string segmented based on the candidate segmentation point, in response to a predetermined operation performed by the user on the displayed candidate segmentation point.

10. The system according to claim 1, wherein, in response to specifying of the position on the displayed document image by the user, the display unit highlights an area of a character string corresponding to the specified position and displays the candidate segmentation point in a manner to be specified.

11. The system according to claim 1, further comprising a server and a terminal,
wherein the server includes the recognition unit and the candidate segmentation unit, and
wherein the terminal includes the display unit and the change unit.

12. An apparatus comprising:
a recognition unit configured to execute character recognition processing on a document image;
a candidate segmentation unit configured to specify a candidate segmentation point in a character string of a recognition result of the character recognition processing; and
a transmission unit configured to transmit information about the document image, the character string of the recognition result, and the candidate segmentation point to a terminal,
wherein the terminal which receives the information displays the document image, sets a character string corresponding to a position specified by a user on the displayed document image as an output target, displays the candidate segmentation point, and, in a case where the displayed candidate segmentation point is operated by the user, changes the character string set as the output target to a character string based on the candidate segmentation point.

13. A method comprising:
executing character recognition processing on a document image;
specifying a candidate segmentation point in a character string of a recognition result of the character recognition processing;
displaying the document image, in the displaying, a character string corresponding to a position specified by a user on the displayed document image being set as an output target and the candidate segmentation point being displayed; and
changing, in a case where the displayed candidate segmentation point is operated by the user, the character string set as the output target to a character string based on the candidate segmentation point.

14. The method according to claim 13, further comprising:
segmenting the character string of the recognition result, using a regular expression definition which associates a regular expression with a parameter relating to a whitespace character,
wherein the segmenting specifies the candidate segmentation point in the character string of the recognition result and in a character string obtained by segmentation performed by segmenting.

15. The method according to claim 13, wherein the displaying sets the character string corresponding to the specified position, identifiably displays an area corresponding to the character string on the document image, and displays the candidate segmentation point.

16. The method according to claim 13, wherein the segmenting specifies the candidate segmentation point, based on a position of a predetermined character in a character string.

17. A non-transitory computer readable storage medium storing a program for causing a processor to perform:
executing character recognition processing on a document image;
specifying a candidate segmentation point in a character string of a recognition result of the character recognition processing;
displaying the document image, in the displaying, a character string corresponding to a position specified by a user on the displayed document image being set as an output target and the candidate segmentation point being displayed; and
changing, in a case where the displayed candidate segmentation point is operated by the user, the character string set as the output target to a character string based on the candidate segmentation point.

18. The non-transitory computer readable storage medium according to claim 17, wherein the processor further performs:
segmenting the character string of the recognition result, using a regular expression definition which associates a regular expression with a parameter relating to a whitespace character,
wherein the segmenting specifies the candidate segmentation point in the character string of the recognition result and in a character string obtained by segmentation performed by segmenting.

19. The non-transitory computer readable storage medium according to claim 17, wherein the displaying sets the character string corresponding to the specified position, identifiably displays an area corresponding to the character string on the document image, and displays the candidate segmentation point.

20. The non-transitory computer readable storage medium according to claim 17, wherein the segmenting specifies the candidate segmentation point, based on a position of a predetermined character in a character string.
